(19) United States
(12) Patent Application Publication
(10) Pub. No.: US 2025/0191120 A1
(43) Pub. Date: Jun. 12, 2025

(54) MOTION VECTOR FIELD GENERATION FOR FRAME INTERPOLATION

(71) Applicant: ADVANCED MICRO DEVICES, INC., Santa Clara, CA (US)

(72) Inventor: Jimmy Stefan Petersson, Stockholm (SE)

(21) Appl. No.: 18/535,171

(22) Filed: Dec. 11, 2023

(51) Int. Cl. G06T 3/40; G06T 7/246

(52) U.S. Cl. CPC G06T 3/4007; G06T 7/246

(57) ABSTRACT

A processing system generates interpolated frames between two rendered frames based on an estimated motion vector field for one or more interpolated frames. The processing system determines a motion vector for a location of the interpolated frame by assigning a weight to each motion vector of the current frame that is estimated to intersect the location. The processing system samples a number of motion vectors of the current frame that are estimated to intersect the location based on the assigned weights to select a motion vector for the location of the interpolated frame. The processing system iterates the process for each location of the interpolated frame to generate a motion vector field and generates pixel values for the interpolated frame based at least in part on the generated motion vector field for the interpolated frame.

### BACKGROUND

Some graphics applications reduce or fix the frame rate at which frames are rendered in order to reduce the processing resources required to produce a set of rendered frames. To compensate for this reduction in frame rate, some processing systems implement frame interpolation techniques to generate one or more interpolated frames from two or more rendered frames within a set of rendered frames. These generated interpolated frames each represent frames that come temporally and spatially between two or more respective rendered frames. After generating the interpolated frames, the processing systems then insert the interpolated frames into the set of rendered frames. By inserting the interpolated frames into the set of rendered frames, the number of frames within the set of rendered frames is increased, which serves to increase the frame rate of the set of rendered frames.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system configured to generate interpolated frames based on a motion vector field sampled from a current frame in accordance with some embodiments.

FIG. 2 is a block diagram of a graphics pipeline implemented by an accelerator unit in accordance with some embodiments.

FIG. 3 illustrates selection of a motion vector for an interpolated frame based on a motion vector for a current frame in accordance with some embodiments.

FIG. 4 illustrates two motion vectors from a current frame intersecting a location of an interpolated frame in accordance with some embodiments.

FIG. 5 illustrates an example operation for generating an interpolated frame using motion vectors selected from weighted motion vectors of a current frame in accordance with some embodiments.

FIG. 6 is a flow diagram illustrating a method for generating an interpolated frame based on motion vectors selected from a current frame in accordance with some embodiments.

### DETAILED DESCRIPTION

Some processing systems are configured to execute applications such as video games that render sets of rendered frames to be presented on a display. Each of these rendered frames represents a scene with one or more graphics objects (e.g., groups of primitives) as viewed by a respective viewpoint (e.g., camera view). As the set of rendered frames is displayed, objects within the rendered frames change position. In addition, the viewpoint of the scene changes which causes pixels representing the graphics objects to be viewed at a first position when a first rendered frame is displayed and at a second position when a second rendered frame is displayed. To help improve processing efficiency, some applications are configured to limit the frame rate at which these rendered frames are rendered such that the resulting set of rendered frames has a reduced number of rendered frames and requires fewer processing resources to render. However, lowering the frame rate in this way causes the set of rendered frames to display at a lower frame rate, causing movement of the pixels representing the graphics objects to appear less smooth and negatively impacting user experience.

To this end, systems and techniques disclosed herein include a processing system configured to generate one or more interpolated frames that each represent a scene with a respective viewpoint or motion of objects in the scene that is temporally between, spatially between, or both temporally and spatially between two or more rendered frames of the set of rendered frames. For example, based on a first rendered frame (e.g., a previous rendered frame) and a second rendered frame (e.g., a current rendered frame) a processing system is configured to generate one or more interpolated frames that represent a scene with a respective viewpoint or motion of objects that is temporally between, spatially between, or both temporally and specially between the first and second rendered frames. After generating the interpolated frame(s), the processing system inserts the interpolated frame(s) into the set of rendered frames between the first and second rendered frames used to generate the interpolated frame. After inserting one or more interpolated frames into the set of rendered frames, the processing system displays the set of rendered frames. Due to the set of rendered frames including one or more interpolated frames, the number of frames within the set of rendered frames is increased, increasing the frame rate of the set of rendered frames when it is displayed. Because the frame rate of the set of rendered frames is increased, the motion of the pixels representing the graphics objects appears smoother when displayed, which improves user experience.

Frames of certain applications such as video games are typically associated with motion vector fields including motion vectors that describe the motion of pixels or sub-pixels from one frame to the next. A motion vector field measures motion between two frames by comparing each unit, or block, of the current and previous (i.e., N and N−1) frames to determine motion vectors for each block. A block is a uniform size of a group of pixels used for block-based motion estimation. In some cases, motion vectors are estimated for each pixel, or per a group of multiple pixels. Based on an analysis of the N and N−1 images, a motion vector field is generated which indicates areas, magnitude, and direction of motion between two frames. In the case of applications such as video games, a motion vector field may be generated and stored for each frame. The motion vector field can be used to generate a next frame, based on pixel values for the previous frame.

To generate interpolated (i.e., intermediate) frames between two rendered frames, a processing system is configured to estimate a motion vector field for one or more interpolated frames based on motion vectors of a current frame. To determine a motion vector for a location (e.g., a pixel or subpixel) of an interpolated frame, the processing system assigns a weight to each motion vector of the current frame that are estimated to intersect the location. In some cases, the weight is based on a distance of the motion vector from a virtual camera position for the interpolated frame. For example, motion vectors that are closer to the virtual camera position of the interpolated frame are assigned a higher weight. In some cases, the weight is further based on a color of the pixel or subpixel location of the interpolated frame. The processing system samples a number of motion vectors of the current frame that are estimated to intersect the location based on the assigned weights to select a motion vector for the location of the interpolated frame. The processing system iterates the process for each location of the interpolated frame to generate a motion vector field and generates pixel values for the interpolated frame based at least in part on the generated motion vector field for the interpolated frame.

In some implementations, the processing system stores each motion vector of the current frame at a storage component such as a buffer. Each motion vector includes an x coordinate and a y coordinate, which are stored at separate storage components but together with the corresponding weight in some implementations. To prevent the x coordinate from one motion vector from being paired with the y coordinate from a different motion vector, the corresponding weight for each coordinate of a given motion vector is as unique as possible. To further guard against disjointed x and y coordinates being used to determine an intermediate motion vector, the processing system samples motion vectors from the current frame by writing atomically to multiple (e.g., four) locations in the vicinity of the pixel or sub-pixel of interest to select a motion vector at the location of the pixel of sub-pixel of interest of the intermediate frame.

If a value for a stored motion vector is zero (e.g., because the sampled location is outside the screen area or in a dis-occluded area), the processing system does not use the zero-value motion vector and instead replaces the zero-value motion vector with an adjacent, non-zero motion vector in some implementations. In some cases, the processing system computes a multi-level mipmap pyramid for the x and y coordinates of a location having a zero-value motion vector in which only non-zero (valid) motion vector data contributes to each level. The processing system assigns a higher weight to adjacent motion vectors that are farthest from a virtual camera location of the intermediate frame and fills the zero-value “hole” using the non-zero sample in the pyramid that is closest spatially to the hole and farthest from the virtual camera location.

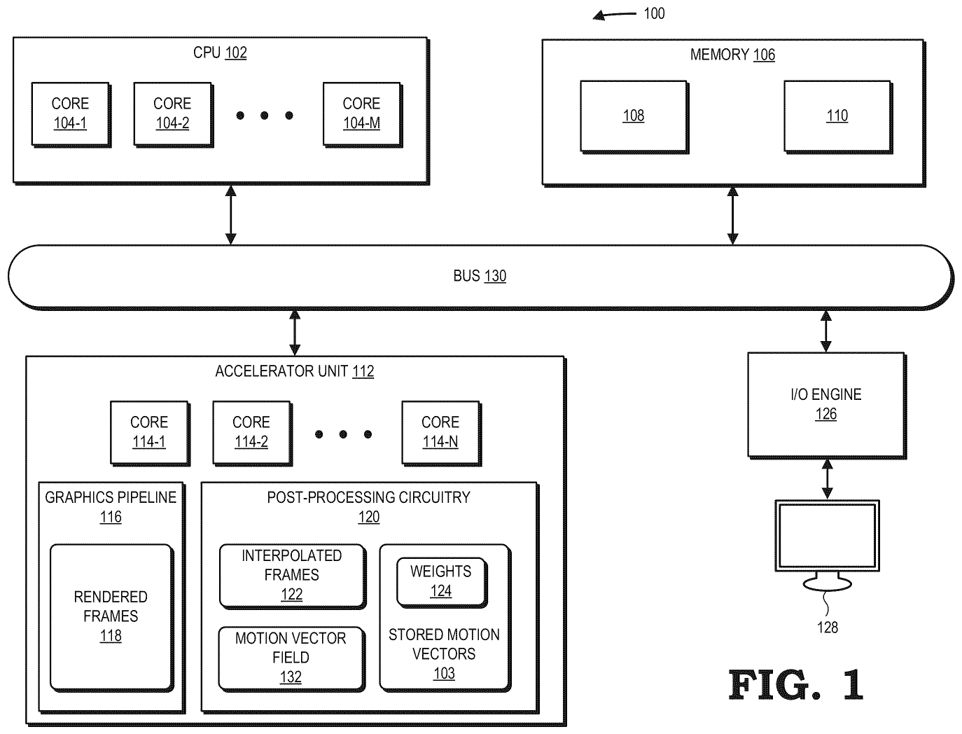

FIG. 1 illustrates a processing system 100 configured to generate interpolated frames based on a motion vector field sampled from a current frame in accordance with some embodiments. Processing system 100 includes or has access to a memory 106 or other storage component implemented using a non-transitory computer-readable medium, for example, a dynamic random-access memory (DRAM). However, in implementations, the memory 106 is implemented using other types of memory including, for example, static random-access memory (SRAM), nonvolatile RAM, and the like. According to implementations, the memory 106 includes an external memory implemented external to the processing units implemented in the processing system 100. The processing system 100 also includes a bus 130 to support communication between entities implemented in the processing system 100, such as the memory 106. Some implementations of the processing system 100 include other buses, bridges, switches, routers, and the like, which are not shown in FIG. 1 in the interest of clarity.

The techniques described herein are, in different implementations, employed at accelerator unit (AU) 112. AU 112 includes, for example, vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (simple programmable logic devices, complex programmable logic devices, field programmable gate arrays (FPGAs), or any combination thereof. AU 112 is configured to render a set of rendered frames 118, each representing respective scenes within a screen space (e.g., the space in which a scene is displayed), according to one or more applications 110 for presentation on a display 128. As an example, AU 112 renders graphics objects (e.g., sets of primitives) for a scene to be displayed so as to produce pixel values representing a rendered frame 118. AU 112 then provides the rendered frame 118 (e.g., pixel values) to display 128. These pixel values include color values (YUV color values, RGB color values), depth values (z-values), or both. After receiving the rendered frame 118, display 128 uses the pixel values of the rendered frame 118 to display the scene including the rendered graphics objects.

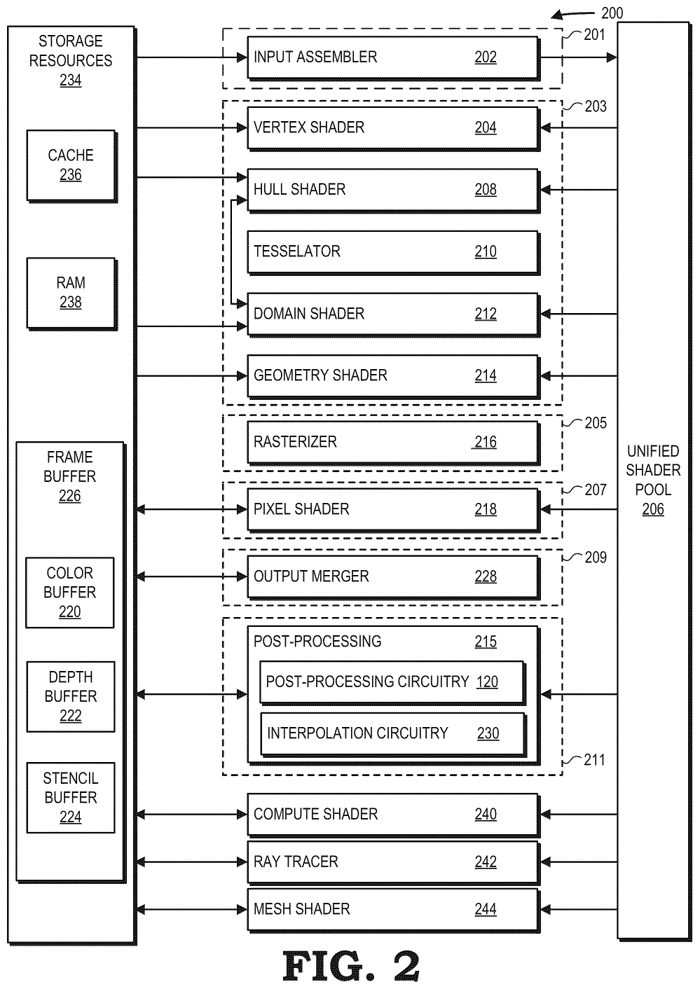

To render the graphics objects, AU 112 implements processor cores 114-1 to 114-N that execute instructions concurrently or in parallel. For example, AU 112 executes instructions, operations, or both from a graphics pipeline 116 using processor cores 114 to render one or more graphics objects. A graphics pipeline 116 includes, for example, one or more steps, stages, or instructions to be performed by AU 112 in order to render one or more graphics objects for a scene. As an example, example graphics pipeline 200 illustrated in FIG. 2 includes data indicating an input assembler stage, vertex shader stage, hull shader stage, tessellator stage, domain shader stage, geometry shader stage, rasterizer stage, pixel shader stage, output merger stage, or any combination thereof to be performed by one or more processor cores 114 of AU 112 in order to render one or more graphics objects for a scene to be displayed.

In embodiments, one or more processor cores 114 of AU 112 each include a plurality of compute units configured to perform one or more operations for one or more instructions received by AU 112. These compute units each include one or more single instruction, multiple data (SIMD) units that perform the same operation on different data sets to produce one or more results. For example, AU 112 includes one or more processor cores 114 each including compute units that include one or more SIMD units to perform operations for one or more instructions from a graphics pipeline 116. To facilitate the performance of operations by the compute units, AU 112 includes one or more command processors (not shown). Such command processors, for example, include circuitry configured to execute one or more instructions from a graphics pipeline 116 by providing data indicating one or more operations, operands, instructions, variables, register files, or any combination thereof to one or more compute units necessary for, helpful for, or aiding in the performance of one or more operations for the instructions.

Though the example implementation illustrated in FIG. 1 presents AU 112 as having three processor cores (114-1, 114-2, 114-N) representing an N number of cores, the number of processor cores 114 implemented in AU 112 is a matter of design choice. As such, in other implementations, AU 112 can include any number of processor cores 114. Some implementations of AU 112 are used for general-purpose computing. For example, in embodiments, AU 112 is configured to receive one or more instructions, such as program code 108, from one or more applications 110 that indicate operations associated with one or more video tasks, physical simulation tasks, computational tasks, fluid dynamics tasks, or any combination thereof, to name a few. In response to receiving the program code 108, AU 112 executes the instructions for the video tasks, physical simulation tasks, computational tasks, and fluid dynamics tasks. AU 112 then stores information in the memory 106 such as the results of the executed instructions.

According to embodiments, AU 112 is configured to render the set of rendered frames 118 at a frame rate based on, for example, an application 110 being executed by processing system 100. For example, AU 112 executes instructions from the application 110 such that AU 112 renders the set of rendered frames 118 at a frame rate indicated by the instructions. To improve the frame rate of the set of rendered frame 118 when the rendered frames 118 are displayed on display 128, AU 112 is configured to generate one or more interpolated frames 122 and insert respective interpolated frames 122 between corresponding rendered frames 118. Such interpolated frames 122, for example, include frames representing a scene that is temporally between, spatially between, or both a first rendered frame of the set of rendered frames 118 and a second frame of the set of rendered frames 118. For example, an interpolated frame 122 represents a scene temporally between, spatially between, or both a current frame of the set of rendered frames 118 and a previous frame of the set of rendered frames 118 (e.g., the frame immediately preceding the current frame in the set of rendered frames 118).

To generate one or more interpolated frames 122, in embodiments, AU 112 includes post-processing circuitry 120. Post-processing circuitry 120, for example, is configured to generate an interpolated frame 122 representing a scene temporally between, spatially between, or both a first frame (e.g., current frame) of the set of rendered frames 118 and a second frame (e.g., immediately preceding frame) of the set of rendered frames based a motion vector field including a plurality of motion vectors 103 of the interpolated frame. A motion vector 103, for example, represents the movement of one or more graphics objects from a first frame (e.g., previous frame) and a second frame (e.g., current frame). As an example, a motion vector 103 represents the movement of one or more pixels from a first position in a first frame to a second position in a second frame. In some implementations, post-processing circuitry 120 is configured to receive motion vectors 103 for the set of rendered frames 118 including a current frame and a previous frame from the application 110.

Post-processing circuitry 120 then uses the motion vectors 103 to determine a motion vector field 132 for an interpolated frame 122. For example, in some implementations, post-processing circuitry 120 determines a motion vector for a location (e.g., a pixel or subpixel) of the interpolated frame 122 by assigning a weight to each motion vector of the current frame that is estimated to intersect the location. The weight assigned to each motion vector is based on a distance (i.e., depth value) from a virtual camera position for the intermediate frame and/or a color associated with the motion vector of the current frame in some implementations. For example, post-processing circuitry 120 assigns a higher weight to motion vectors that are closer to the virtual camera position of the intermediate frame. In some cases, the weight is further based on reprojected color similarity between the previous frame and current frame colors. Post-processing circuitry 120 samples a number of motion vectors 103 of the current frame that are estimated to intersect the location based on the assigned weights and selects a motion vector for the location, for example, by selecting the motion vector for the location that is nearest to the virtual camera position. Post-processing circuitry 120 repeats this process for each location of the interpolated frame to generate a motion vector field 132 for the interpolated frame.

For locations for which one or more motion vectors 103 are invalid (e.g., have a zero value), post-processing circuitry 120 replaces the invalid motion vector with an adjacent, non-zero motion vector in some implementations. In some cases, post-processing circuitry 120 computes a multi-level mipmap pyramid for a location having a zero-value motion vector in which only non-zero (valid) motion vector data contributes to each level. Post-processing circuitry 120 assigns a higher priority (weight) to adjacent motion vectors that are farthest from a virtual camera location of the intermediate frame and fills the location of the invalid motion vector 103 (i.e., the hold) using the non-zero sample in the pyramid that is closest spatially to the hole and farthest from the virtual camera location.

Based on the motion vector field 132 for the interpolated frame 122, the color values of the first and second frames, and the depth values of the first and second frames, post-processing circuitry 120 determines the interpolated frame 122 representing a scene temporally between, spatially between, or both the first frame and the second frame. For example, based on the motion vector field for the interpolated frame, the color values of the first and second frames, and the depth values of the first and second frames, post-processing circuitry 120 is configured to synthesize pixel values (e.g., color values and depth values) for each pixel of the interpolated frame 122. To this end, in embodiments, post-processing circuitry 120 implements one or more machine machine-learning models, neural networks (e.g., artificial neural networks, convolution neural networks, recurrent neural networks), or both configured to output pixel values for each pixel of an interpolated frame 122 based on receiving the motion vectors 103, the color values of the first and second frames, the depth values of the first and second frames, or any combination thereof as inputs. For example, in some embodiments, post-processing circuitry 120 is configured to implement a depth-aware frame interpolation neural network to synthesize pixel values for an interpolated frame 122.

After generating the pixel values of the interpolated frame 122, post-processing circuitry 120 inserts the interpolated frame 122 into the set of rendered frames 118. For example, post-processing circuitry 120 inserts the interpolated frame 122 between the first frame and the second frame within the set of rendered frames 118. AU 112 then provides the set of rendered frames 118 with one or more interpolated frames 122 to display 128. In response to receiving the set of rendered frames 118 with one or more interpolated frames 122, display 128 displays each rendered frame and interpolated frame 122 of the set of rendered frames 118 such that the displayed frames have a greater frame rate when compared to a set of rendered frames 118 without any interpolated frames 122. Thus, because inserting the interpolated frames 122 into the set of rendered frames 118 increases the number of frames in the set of rendered frames 118, the frame rate of the set of rendered frames 118 when displayed is increased.

In some embodiments, the processing system 100 includes input/output (I/O) engine 126 that includes circuitry to handle input or output operations associated with display 128, as well as other elements of the processing system 100 such as keyboards, mice, printers, external disks, and the like. The I/O engine 126 is coupled to the bus 130 so that the I/O engine 126 communicates with the memory 106, AU 112, or the central processing unit (CPU) 102.

In some embodiments, the processing system 100 also includes CPU 102 that is connected to the bus 130 and therefore communicates with AU 112 and the memory 106 via the bus 130. CPU 102 implements a plurality of processor cores 104-1 to 104-M that execute instructions concurrently or in parallel. In implementations, one or more of the processor cores 104 operate as SIMD units that perform the same operation on different data sets. Though in the example implementation illustrated in FIG. 1, three processor cores (104-1, 104-2, 104-M) are presented representing an M number of cores, the number of processor cores 104 implemented in CPU 102 is a matter of design choice. As such, in other implementations, CPU 102 can include any number of processor cores 104. In some implementations, CPU 102 and AU 112 have an equal number of processor cores 104, 114 while in other implementations, CPU 102 and AU 112 have a different number of processor cores 104, 114. The processor cores 104 of CPU 102 are configured execute instructions such as program code 108 for one or more applications 110 (e.g., graphics applications, compute applications, machine-learning applications) stored in the memory 106, and CPU 102 stores information in the memory 106 such as the results of the executed instructions. CPU 102 is also able to initiate graphics processing by issuing draw calls to AU 112.

Referring now to FIG. 2, a block diagram of an example graphics pipeline 200 is presented, in accordance with some embodiments. In some embodiments, example graphics pipeline 200 is implemented in processing system 100 as graphics pipeline 116. Example graphics pipeline 200 is configured to render graphics objects as images that depict a scene which has three-dimensional geometry in virtual space (also referred to herein as “screen space”), but potentially a two-dimensional geometry. Example graphics pipeline 200 typically receives a representation of a three-dimensional scene, processes the representation, and outputs a two-dimensional raster image. Various stages of example graphics pipeline 200 process data that is initially properties at end points (or vertices) of a geometric primitive, where the primitive provides information on an object being rendered. Typical primitives in three-dimensional graphics include triangles and lines, where the vertices of these geometric primitives provide information on, for example, x-y-z coordinates, texture, and reflectivity.

According to some embodiments, example graphics pipeline 200 has access to storage resources 234 (also referred to herein as “storage components”). Storage resources 234 include, for example, a hierarchy of one or more memories or caches that are used to implement buffers and store vertex data, texture data, and the like for example graphics pipeline 200. In some embodiments, storage resources 234 are implemented within processing system 100 using respective portions of system memory 106. In some embodiments, storage resources 234 include or otherwise have access to one or more caches 236, one or more random access memory (RAM) units 238, video random access memory unit(s) (not pictured for clarity), one or more processor registers (not pictured for clarity), and the like, depending on the nature of data at the particular stage of example graphics pipeline 200. Accordingly, it is understood that storage resources 234 refer to any processor-accessible memory utilized in the implementation of example graphics pipeline 200.

Example graphics pipeline 200, for example, includes stages that each perform respective functionalities. For example, these stages represent subdivisions of functionality of example graphics pipeline 200. Each stage is implemented partially or fully as shader programs executed by AU 112. According to embodiments, stages 201 and 203 of example graphics pipeline 200 represent the front-end geometry processing portion of example graphics pipeline 200 prior to rasterization. Stages 203 to 211 represent the back-end pixel processing portion of example graphics pipeline 200.

During input assembler stage 201 of example graphics pipeline 200, an input assembler 202 is configured to access information from the storage resources 234 that is used to define objects that represent portions of a model of a scene. For example, in various embodiments, the input assembler 202 includes circuitry configured to read primitive data (e.g., points, lines and/or triangles) from user-filled buffers (e.g., buffers filled at the request of software executed by processing system 100, such as an application 110) and assembles the data into primitives that will be used by other pipeline stages of the example graphics pipeline 200. “User”, as used herein, refers to an application 110 or other entity that provides shader code and three-dimensional objects for rendering to example graphics pipeline 200. In some embodiments, the input assembler 202 is configured to assemble vertices into several different primitive types (e.g., line lists, triangle strips, primitives with adjacency) based on the primitive data include in the user-filled buffers and formats the assembled primitives for use by the rest of example graphics pipeline 200.

According to some embodiments, example graphics pipeline 200 operates on one or more virtual objects defined by a set of vertices set up in the screen space and having geometry that is defined with respect to coordinates in the scene. For example, the input data utilized in example graphics pipeline 200 includes a polygon mesh model of the scene geometry whose vertices correspond to the primitives processed in the rendering pipeline in accordance with aspects of the present disclosure, and the initial vertex geometry is set up in the storage resources 234 during an application stage implemented by, for example, CPU 102.

During the vertex processing stage 203 of example graphics pipeline 200, one or more vertex shaders 204 are configured to process vertices of the primitives assembled by the input assembler 202. For example, a vertex shader 204 includes circuitry configured to first receive a single vertex of a primitive as an input and outputs a single vertex. The vertex shader 204 then performs various per-vertex operations such as transformations, skinning, morphing, per-vertex lighting, or any combination thereof, to name a few. Transformation operations include various operations to transform the coordinates (e.g., X-Y coordinate, Z-depth values) of the vertices. These operations include, for example, one or more modeling transformations, viewing transformations, projection transformations, perspective division, viewport transformations, or any combination thereof. Herein, such transformations are considered to modify the coordinates or “position” of the vertices on which the transforms are performed. Other operations of the vertex shader 204 modify attributes other than the coordinates.

In some embodiments, one or more vertex shaders 204 are implemented partially or fully as vertex shader programs to be executed on one or more processor cores 114 (e.g., one or more processor cores 114 operating as compute units). Some embodiments of shaders such as the vertex shader 204 implement massive single-instruction-multiple-data (SIMD) processing so that multiple vertices are processed concurrently. In at least some embodiments, example graphics pipeline 200 implements a unified shader model so that all the shaders included in example graphics pipeline 200 have the same execution platform on the shared massive SIMD units of the processor cores 114. In such embodiments, the shaders, including one or more vertex shaders 204, are implemented using a common set of resources that is referred to herein as the unified shader pool 206.

During the vertex processing stage 203, in some embodiments, one or more vertex shaders 204 perform additional vertex processing computations that subdivide primitives and generate new vertices and new geometries in the screen space. These additional vertex processing computations, for example, are performed by one or more of a hull shader 208, a tessellator 210, a domain shader 212, and a geometry shader 214. The hull shader 208, for example, includes circuitry configured to operate on input high-order patches or control points that are used to define the input patches. Additionally, the hull shader 208 outputs tessellation factors and other patch data. According to some embodiments, within example graphics pipeline 200, primitives generated by the hull shader 208 are provided to the tessellator 210. The tessellator 210 includes circuitry configured to receive objects (such as patches) from the hull shader 208 and generate information identifying primitives corresponding to the input objects, for example, by tessellating the input objects based on tessellation factors provided to the tessellator 210 by the hull shader 208. Tessellation, as an example, subdivides input higher-order primitives such as patches into a set of lower-order output primitives that represent finer levels of detail (e.g., as indicated by tessellation factors that specify the granularity of the primitives produced by the tessellation process). As such, a model of a scene is represented by a smaller number of higher-order primitives (e.g., to save memory or bandwidth) and additional details are added by tessellating the higher-order primitive.

The domain shader 212 includes circuitry configured to receive a domain location, other patch data, or both as inputs. The domain shader 212 is configured to operate on the provided information and generate a single vertex for output based on the input domain location and other information. The geometry shader 214 includes circuitry configured to receive a primitive as an input and generate up to four primitives based on the input primitive. In some embodiments, the geometry shader 214 retrieves vertex data from storage resources 234 and generates new graphics primitives, such as lines and triangles, from the vertex data in storage resources 234. In particular, the geometry shader 214 retrieves vertex data for a primitive and generates one or more primitives. To this end, for example, the geometry shader 214 is configured to operate on a triangle primitive with three vertices. A variety of different types of operations can be performed by the geometry shader 214, including operations such as point sprint expansion, dynamic particle system operations, fur-fin generation, shadow volume generation, single pass render-to-cubemap, per-primitive material swapping, per-primitive material setup, or any combination thereof. According to embodiments, the hull shader 208, the domain shader 212, the geometry shader 214, or any combination thereof are implemented as shader programs to be executed on the processor cores 114, whereas the tessellator 210, for example, is implemented by fixed-function hardware.

Once front-end processing (e.g., stages 201, 203) of example graphics pipeline 200 is complete, the scene is defined by a set of vertices which each have a set of vertex parameter values stored in the storage resources 234. In certain implementations, the vertex parameter values output from the vertex processing stage 203 includes positions defined with different homogeneous coordinates for different zones.

As described above, stages 205 to 211 represent the back-end processing of example graphics pipeline 200. The rasterizer stage 205 includes a rasterizer 216 having circuitry configured to accept and rasterize simple primitives that are generated upstream. The rasterizer 216 is configured to perform shading operations and other operations such as clipping, perspective dividing, scissoring, viewport selection, and the like. In embodiments, the rasterizer 216 is configured to generate a set of pixels that are subsequently processed in the pixel processing/shader stage 207 of the example graphics processing pipeline. In some implementations, the set of pixels includes one or more tiles. In one or more embodiments, the rasterizer 216 is implemented by fixed-function hardware.

The pixel processing stage 207 of example graphics pipeline 200 includes one or more pixel shaders 218 that include circuitry configured to receive a pixel flow (e.g., the set of pixels generated by the rasterizer 216) as an input and output another pixel flow based on the input pixel flow. To this end, a pixel shader 218 is configured to calculate pixel values for screen pixels based on the primitives generated upstream and the results of rasterization. In embodiments, the pixel shader 218 is configured to apply textures from a texture memory, which, according to some embodiments, is implemented as part of the storage resources 234. The pixel values generated by one or more pixel shaders 218 include, for example, color values, depth values, and stencil values, and are stored in one or more corresponding buffers, for example, a color buffer 220, a depth buffer 222, and a stencil buffer 224, respectively. The combination of the color buffer 220, the depth buffer 222, the stencil buffer 224, or any combination thereof is referred to as a frame buffer 226. In some embodiments, example graphics pipeline 200 implements multiple frame buffers 226 including front buffers, back buffers and intermediate buffers such as render targets, frame buffer objects, and the like. Operations for the pixel shader 218 are performed by a shader program that executes on the processor cores 114.

According to embodiments, the pixel shader 218, or another shader, accesses shader data, such as texture data, stored in the storage resources 234. Such texture data defines textures which represent bitmap images used at various points in example graphics pipeline 200. For example, the pixel shader 218 is configured to apply textures to pixels to improve apparent rendering complexity (e.g., to provide a more “photorealistic” look) without increasing the number of vertices to be rendered. In another instance, the vertex shader 204 uses texture data to modify primitives to increase complexity, by, for example, creating or modifying vertices for improved aesthetics. AS an example, the vertex shader 204 uses a height map stored in storage resources 234 to modify displacement of vertices. This type of technique can be used, for example, to generate more realistic-looking water as compared with textures only being used in the pixel processing stage 207, by modifying the position and number of vertices used to render the water. The geometry shader 214, in some embodiments, also accesses texture data from the storage resources 234.

Within example graphics pipeline 200, the output merger stage 209 includes an output merger 228 accepting outputs from the pixel processing stage 207 and merges these outputs. As an example, in embodiments, output merger 228 includes circuitry configured to perform operations such as z-testing, alpha blending, stenciling, or any combination thereof on the pixel values of each pixel received from the pixel shader 218 to determine the final color for a screen pixel. For example, the output merger 228 combines various types of data (e.g., pixel values, depth values, stencil information) with the contents of the color buffer 220, depth buffer 222 and, in some embodiments, the stencil buffer 224 and stores the combined output back into the frame buffer 226. The output of the output merger stage 209 can be referred to as rendered pixels that collectively form a rendered frame 118. In one or more implementations, the output merger 228 is implemented by fixed-function hardware.

In some embodiments, example graphics pipeline 200 includes a post-processing stage 211 implemented after the output merger stage 209. During the post-processing stage 211, post-processing circuitry 120 operates on the rendered frame stored (or individual pixels) stored in the frame buffer 226 to apply one or more post-processing effects, such as ambient occlusion or tone mapping, prior to the frame being output to the display. The post-processed frame is written to a frame buffer 226, such as a back buffer for display or an intermediate buffer for further post-processing. The example graphics pipeline 200, in some embodiments, includes other shaders or components, such as a computer shader 240, a ray tracer 242, a mesh shader 244, and the like, which are configured to communicate with one or more of the other components of example graphics pipeline 200.

In some embodiments, to help improve the frame rate of a set of rendered frame 118 rendered by the example graphics pipeline 200, post-processing stage 215 includes interpolation circuitry 230 generating one or more interpolated frames 122. Interpolation circuitry 230, according to some embodiments, is implemented within or otherwise connected to post-processing circuitry 120. To generate an interpolated frame 122, interpolation circuitry 230 is configured to generate a motion vector field 132 that is based on selected one or more motion vectors 103 that are associated with a current frame of the rendered frames 118. The one or more motion vectors 103 that are associated with the current frame are provided by the application 110 in some embodiments.

In other embodiments, the motion vectors 103 are generated by the interpolation circuitry 230. For example, interpolation circuitry 230 first retrieves pixel data (e.g., color values, depth values) of a first rendered frame (e.g., current frame) from respective color buffers 220 and depth buffers 222 associated with the first rendered frame. Further, interpolation circuitry 230 retrieves pixel data of a second rendered frame (e.g., previous frame) from respective color buffers 220 and depth buffers 222 associated with the second rendered frame. In embodiments, the second rendered frame is the frame within a set of rendered frames 118 immediately preceding the first frame. Interpolation circuitry 230 then implements one or more motion estimation techniques based on the pixel values associated with the first rendered frame and the pixel values associated with the second rendered frame to output one or more motion vectors 103.

Based on one or more of the application-provided or determined motion vectors 103, interpolation circuitry 230 is configured to select one or more motion vectors 103 to generate a motion vector field 132 for the interpolated frame 122. For example, in some embodiments, interpolation circuitry 230 assigns weights to motion vectors 103 of the current frame based on depth and/or color values associated with the motion vectors 103. Interpolation circuitry 230 samples motion vectors 103 of the current frame that intersect a location of the interpolated frame 122 and selects the motion vector intersecting the location that has the highest weight. Interpolation circuitry 230 reiterates this process for multiple locations of the interpolated frame 122 and uses the selected motion vectors to generate the motion vector field 132 for the interpolated frame 122.

Interpolation circuitry 230 generates pixel values (e.g., color values, depth values, stencil values) for the interpolated frame 122 that represents a scene temporally between, spatially between, or both the first rendered frame and the second rendered frame by sampling from each selected motion vector of the motion vector field 132 in both directions to fetch pixel values from the current frame and the previous frame. After generating the pixel values for the interpolated frame 122, interpolation circuitry 230 stores the pixel values in respective color buffers 220, depth buffers 222, and stencil buffers 224.

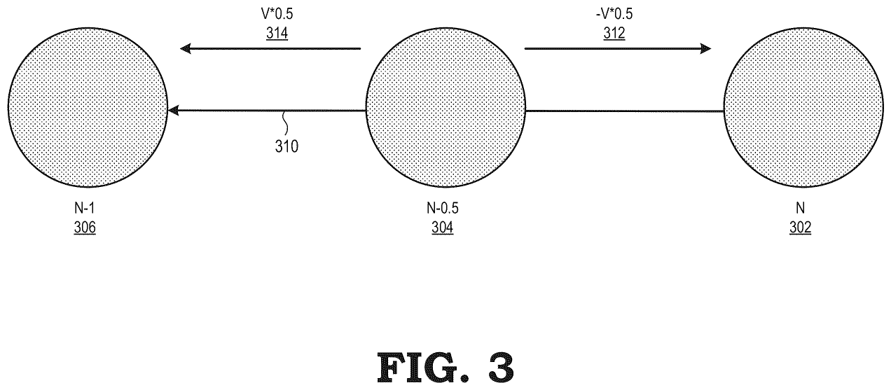

FIG. 3 illustrates a selection of a motion vector for an interpolated frame 122 based on a motion vector for a current frame. In the illustrated example, a motion vector 310 describes motion of a pixel (or sub-pixel) from a first location N 302 in a current frame to a second location N−1 306 in a previous frame. The motion vector 310 intersects a location referred to herein as location N−0.5 304 that is halfway between the first location N 302 and the second location N−1 306 for an interpolated frame that is halfway between the current frame and the previous frame. Interpolation circuitry 230 stores the motion vector 310 for the location N−0.5 304 and samples the motion vector 310 in both directions (e.g., toward the N location, indicated by vector −v*0.5 312, and toward the N−1 location, indicated by vector v*0.5 314) to retrieve pixel values from the current frame and the previous frame and interpolate the retrieved pixel values to generate pixel values for the location N−0.5 304 of the interpolated frame 122.

In the illustrated example, a single frame is interpolated halfway between the current frame N 302 and the previous frame N−1 306. In other embodiments, additional (e.g., 2, 3, . . . , M) frames may be interpolated between the current frame N 302 and the previous frame N−1 306. For additional interpolated frames between the current frame N 302 and the previous frame N−1 306, interpolation circuitry 230 stores motion vectors intersecting additional locations (e.g., an N−0.3 location and an N−0.67 location if two interpolated frames are to be inserted between the current frame N 302 and the previous frame N−1 306).

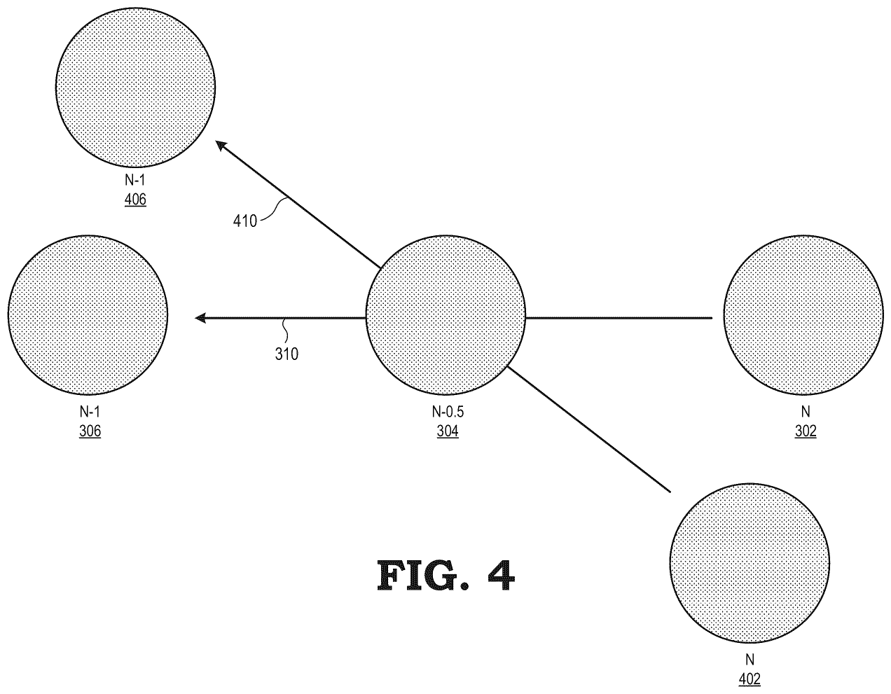

In some cases, more than one current motion vector intersects the location N−0.5 304 (or other sampling location for an interpolated frame). For example, FIG. 4 illustrates two motion vectors from the current frame intersecting the location N−0.5 304 of the interpolated frame 122. In addition to the motion vector 310, which describes motion of a pixel (or sub-pixel) from the first location N 302 in the current frame to the second location N−1 306 in the previous frame, motion vector 410, which describes motion of a pixel (or sub-pixel) from a first location N 402 in the current frame to a second location N−1 406 in the previous frame, intersects the location N−0.5 304 of the interpolated frame.

In order to accurately sample pixel values from the current and previous frames to generate the interpolated frame 122, interpolation circuitry 230 selects either the motion vector 310 or the motion vector 410 for the location N−0.5 304 based on which motion vector has a higher weight (priority). Accordingly, interpolation circuitry 230 assigns a weight to each motion vector of the current frame indicating a confidence level that the motion vector reliably describes motion for the N−0.5 location 304 of the interpolated frame 122. In some embodiments, the weight is based on a distance of the motion vector from a virtual camera position of the interpolated frame 122 (i.e., the depth values of pixels of the current and previous frames associated with the motion vector), color values of the pixels of the current and previous frames associated with the motion vector, or both. In some embodiments, interpolation circuitry 230 assigns higher weights to motion vectors that are closer to the virtual camera position of the interpolated frame 122 and lower weights to motion vectors that are farther from the virtual camera position of the interpolated frame 122. In some embodiments in which interpolation circuitry 230 assigns weights additionally based on color values, interpolation circuitry 230 relies more heavily on the depth values than on the color values in assigning the weights.

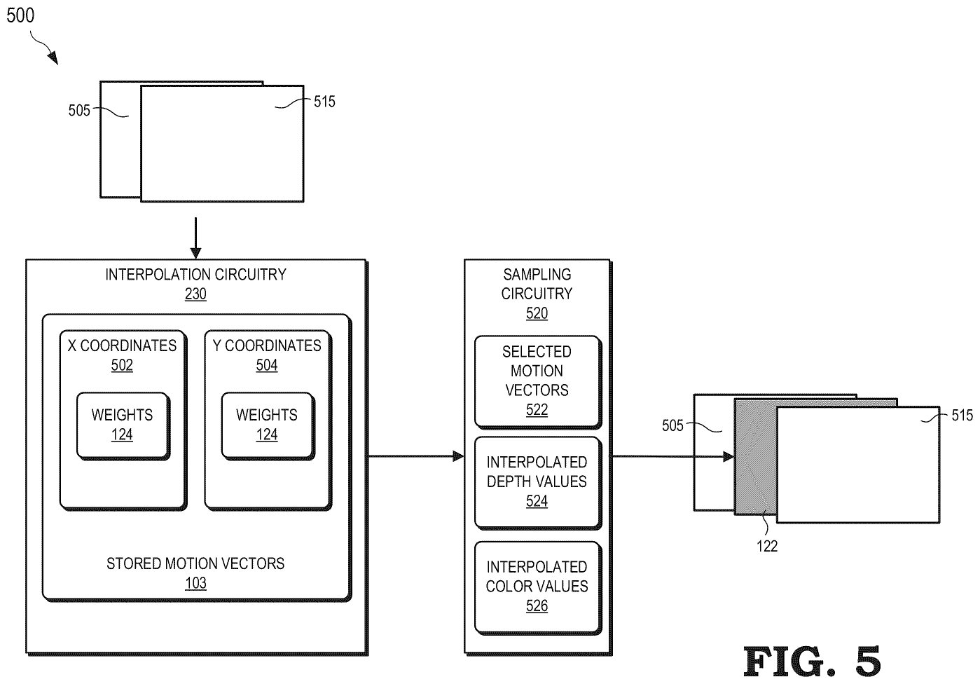

Referring now to FIG. 5, an example operation 500 for generating an interpolated frame 122 using motion vectors selected from weighted motion vectors of a current frame is presented. In some embodiments, example operation 500 is implemented by AU 112. According to some embodiments, example operation 500 first includes interpolation circuitry 230 receiving pixel data associated with a first rendered frame 505 and a second rendered frame 515. For example, example operation 500 first includes interpolation circuitry 230 retrieving color data, depth data, stencil data, or any combination thereof associated with the first rendered frame 505 and the second rendered frame 515 from respective depth buffers 222. According to some embodiments, the first rendered frame 505 and the second rendered frame 515 are part of the set of rendered frames 118 and each represents a respective scene having a respective viewpoint. Further, in some embodiments, the first rendered frame 505 immediately precedes the second rendered frame 515 in the set of rendered frames 118 such that the first rendered frame 505 and second rendered frame 515 represent scenes that are temporally adjacent, spatially adjacent, or both.

According to some embodiments, example operation 500 includes interpolation circuitry 230 accessing one or more stored motion vectors 103 based on the pixel data (e.g., color values, depth values, stencil values) associated with a first rendered frame 505 and a second rendered frame 515. Such stored motion vectors 103, for example, represent the movement of one or more pixels from a first viewpoint represented by the first rendered frame 505 to the second viewpoint represented by the second rendered frame 515. In some embodiments, the stored motion vectors 103 are provided by a gaming engine (not shown) or the application 110. In other embodiments, the stored motion vectors 103 are generated by interpolation circuitry 230, for example, by implementing one or more motion estimation techniques using the pixel data associated with the first rendered frame 505 and the second rendered frame 515 as inputs. In some embodiments, after accessing or generating one or more stored motion vectors 103, interpolation circuitry 230 is configured to store the motion vectors 103 in one or more motion vector buffers. Such motion vector buffers, for example, use at least a portion of storage resources 234.

In some embodiments, x and y coordinates of the stored motion vectors 103 are stored in separate motion vector buffers. In the illustrated example, x coordinates 502 of the stored motion vectors 103 are stored in a first motion vector buffer and y coordinates 504 of the stored motion vectors 103 are stored in a second motion vector buffer together with the weights 124 of the stored motion vectors 103. In some embodiments, the weights 124 are based on a distance from a virtual camera position of the interpolated frame, a color of one or more pixels associated with the motion vector, or both. To prevent sampling of an x coordinate of a motion vector and a y coordinate of a different motion vector, in some embodiments, interpolation circuitry 230 assigns a weight 124 to each motion vector that is as unique as possible. In this way, by ensuring that the weight 124 for an x coordinate matches the weight 124 for a y coordinate, interpolation circuitry 230 avoids disjointed sampling of x and y coordinates of different motion vectors. In other embodiments, the x and y coordinates of the stored motion vectors 103 and the weight 124 for each motion vector are stored in a single (e.g., 64-bit) sample at a motion vector buffer and thereby avoid disjointed sampling of the x and y coordinates of different motion vectors. In addition, to indicate that each location of the interpolated frame 122 was intersected (visited) by at least one motion vector, each motion vector is assigned a weight 124 of at least 1 in some embodiments.

After interpolation circuitry 230 assigns weights 124 to each motion vector, example operation 500 includes sampling circuitry 520, included in other otherwise connected to post-processing circuitry 120, selecting motion vectors for sampled locations of the interpolated frame 122. Sampling circuitry 520 selects a motion vector of the stored motion vectors 103 for a location of the interpolated frame 122 based on the weights of the stored motion vectors 103 that intersect the location. In some embodiments, sampling circuitry 520 scatters the per N sample vector (v) using bilinear sampling logic to the N−0.5 locations. In some embodiments, sampling circuitry 520 scatters the stored motion vectors 103 on a per-x and -y component using atomic operations. For an N−0.5 location (or other location ⅓, or ¼, or 1/M of the distance between endpoints of the motion vector, depending on how many frames are being interpolated between the current rendered frame and the previous rendered frame) at which multiple stored motion vectors 103 intersect, sampling circuitry 520 selects the motion vector having the highest weight 124. In some embodiments, the motion vector having the highest weight 124 is the motion vector that is nearest to the virtual camera position of the interpolated frame 122.

In some cases, a stored motion vector 103 will have an invalid (e.g., zero) value. For example, if the virtual camera position shifts from one frame to the next such that objects that were previously not within screen space are now within screen space, pixels associated with those objects may not be associated with valid motion vectors. Similarly, if a pixel was occluded in a previous frame but is disoccluded in the current frame, the pixel may not be associated with a valid motion vector. To avoid sampling invalid motion vectors, in some embodiments, interpolation circuitry 230 is configured to replace invalid motion vectors (i.e., fill holes) with adjacent valid motion vectors. In some embodiments, interpolation circuitry 230 computes a multi-level mip-map pyramid for each of the x coordinates 502 and y coordinates 504 of the stored motion vectors 103 in which only valid (non-zero) motion vector data contributes to each level. For purposes of replacing invalid motion vectors, in some embodiments, interpolation circuitry 230 prioritizes non-zero motion vectors adjacent to invalid motion vectors that are furthest from the virtual camera position (e.g., by inverting the depth weight). In this way, interpolation circuitry 230 fills holes using the non-zero sample in the multi-level mip-map pyramid that is spatially closest to the invalid motion vector but furthest from the virtual camera position.

Based on selected motion vectors 522, interpolation circuitry 230 is configured to generate an interpolated frame 122 representing a scene with a respective viewpoint that is temporally between, spatially between, or both the first rendered frame 505 and the second rendered frame 515. To this end, interpolation circuitry 230 generates interpolated depth values 524 and interpolated color values 526 for the interpolated frame 122 based on the selected motion vectors 522, the pixel data associated with the first rendered frame 505, and the pixel data associated with the second rendered frame 515. For example, sampling circuitry 520 implements one or more machine machine-learning models, neural networks (e.g., artificial neural networks, convolution neural networks, recurrent neural networks), or both configured to output interpolated depth values 524 and interpolated color values 526 based the selected motion vectors 522, the pixel data associated with the first rendered frame 505, and the pixel data associated with the second rendered frame 515. As an example, in some embodiments, interpolation circuitry 230 is configured to implement a depth-aware frame interpolation neural network to synthesize interpolated depth values 524 and interpolated color values 526.

After generating the interpolated depth values 524 and interpolated color values 526, sampling circuitry 520 stores the interpolated depth values 524 and interpolated color values 526 in one or more output buffers for display on display 128, performs further post-processing techniques on the interpolated depth values 524 and interpolated color values 526, or both. As an example, sampling circuitry 520 stores the interpolated depth values 524 and interpolated color values 526 in one or more output buffers such that interpolated frame 122 is inserted between the first rendered frame 505 and the second rendered frame 515 within a set of rendered frames 118.

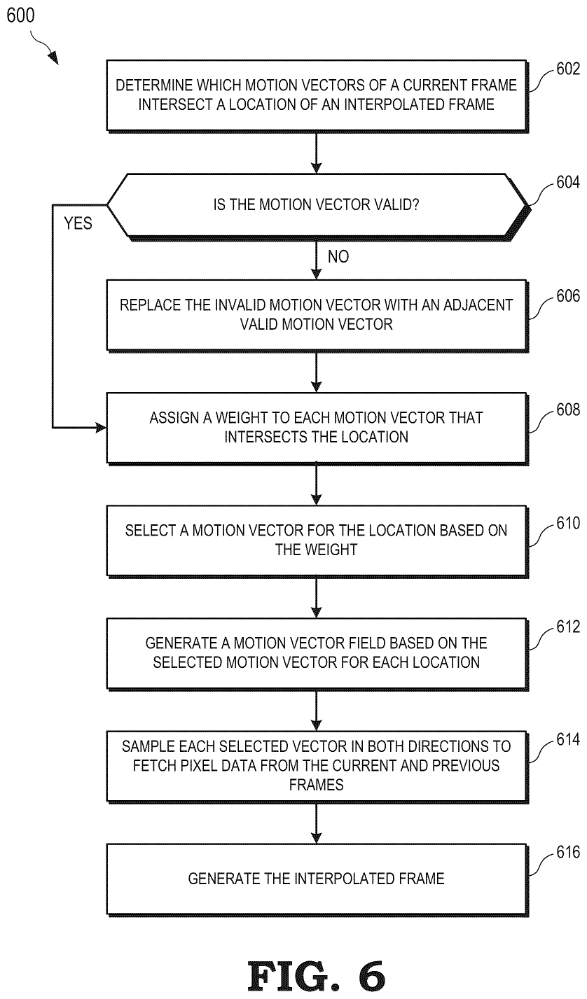

FIG. 6 is a flow diagram illustrating a method 600 for generating an interpolated frame based on motion vectors selected from a current frame in accordance with some embodiments. In some embodiments, the method 600 is performed by a processing system such as processing system 100.

At block 602, accelerator unit 112 accesses stored motion vectors 103 and determines which motion vectors of a current rendered frame intersect a location of an interpolated frame 122. For example, in some embodiments, interpolation circuitry 230 of post-processing circuitry 215 samples x coordinates 502 and y coordinates 504 of the stored motion vectors 103 of the current rendered frame to determine which motion vectors intersect the location. At block 604, interpolation circuitry 230 determines whether each motion vector that intersects the location includes valid data. For example, if the location was off-screen or occluded in the current rendered frame or in the previous rendered frame, the magnitude of the motion vector intersecting the location may be zero.

If, at block 604, interpolation circuitry 230 determines that a motion vector that intersects the location includes invalid (e.g., zero) data, the method flow continues to block 606. At block 606, interpolation circuitry 230 replaces the invalid motion vector data with an adjacent valid motion vector. For example, in some embodiments, interpolation circuitry 230 computes a multi-level mip-map pyramid for each of the x coordinates 502 and y coordinates 504 of the stored motion vectors 103 in which only valid (non-zero) motion vector data contributes to each level. In some embodiments, interpolation circuitry 230 assigns a higher weight to non-zero motion vectors adjacent to invalid motion vectors that are furthest from the virtual camera position, for example, by inverting the depth weight. Interpolation circuitry 230 thus replaces invalid motion vector data with the non-zero motion vector data in the multi-level mip-map pyramid that is spatially closest to the invalid motion vector but furthest from the virtual camera position. The method flow then continues to block 608.

If, at block 604, interpolation circuitry 230 determines that the motion vector data for motion vectors intersecting the location is valid, the method flow continues to block 608. At block 608, interpolation circuitry 230 assigns a weight 124 to each motion vector that intersects the location. In some embodiments, the weight 124 is based on a depth value indicating a distance of the pixel or sub-pixel of the location from a virtual camera position, a color of the pixel or sub-pixel associated with the motion vector, or both. Interpolation circuitry 230 prioritizes depth values over color values in some embodiments, for example, by storing bits describing the depth value at higher bits and storing bits describing color at lower bits of the weight 124. In some embodiments, the weight 124 is manually assigned, for example, by applying a mask to weight motion vector samples.

At block 610, sampling circuitry 520 selects a motion vector from the stored motion vectors 103 that intersect the location based on the weights 124 of the stored motion vectors 103. For example, in some embodiments, if multiple stored motion vectors 103 from the current rendered frame intersect the location of the interpolated frame 122, sampling circuitry 520 samples the stored motion vectors 103 by following each motion vector halfway (or ⅓ or ¼, or 1/M along the motion vector from each endpoint, depending on how many frames are being interpolated between the current rendered frame and the previous rendered frame) and writing atomically to the location multiple times (e.g., four times). Sampling circuitry 520 then selects the motion vector having the highest weight (e.g., the motion vector that is nearest to the virtual camera position of the interpolated frame) for the location.

At block 612, sampling circuitry 520 repeats the process of block 610 for each location of the interpolated frame to generate a motion vector field 132 that includes the selected motion vector for each sampled location. At block 614, sampling circuitry samples each selected motion vector bilinearly (i.e., in both directions) to fetch pixel data such as depth values and color values stored at, e.g., color buffer 220 and depth buffer 222, for the current rendered frame and the previous rendered frame. Based on the fetched pixel data, sampling circuitry 520 generates interpolated depth values 524 and interpolated color values 526. At block 616, sampling circuitry 520 generates the pixel values of the interpolated frame 122 based on the interpolated depth values 524 and the interpolated color values 526.

After generating the pixel values of the interpolated frame 122, post-processing circuitry 120 inserts the interpolated frame 122 into the set of rendered frames 118. For example, post-processing circuitry 120 inserts the interpolated frame 122 between the current rendered frame and the previous rendered frame within the set of rendered frames 118. AU 112 then provides the set of rendered frames 118 with one or more interpolated frames 122 to display 128. In response to receiving the set of rendered frames 118 with one or more interpolated frames 122, display 128 displays each rendered frame and interpolated frame 122 of the set of rendered frames 118 such that the displayed frames have a greater frame rate when compared to a set of rendered frames 118 without any interpolated frames 122.

In some embodiments, the apparatus and techniques described above are implemented in a system including one or more integrated circuit (IC) devices (also referred to as integrated circuit packages or microchips), such as the processing system described above with reference to FIGS. 1-6. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry”, etc.) are described or claimed as “configured” to perform one or more tasks or operations. This formulation—[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
assigning a weight to each motion vector of a plurality of motion vectors of a current frame that are estimated to intersect a first location of an interpolated frame between the current frame and a previous frame;
selecting a first motion vector from the plurality of motion vectors based on the weight of the first motion vector to generate a motion vector field for the interpolated frame; and
generating the interpolated frame based on the motion vector field.

2. The method of claim 1, wherein the weight is based on a distance of the first motion vector from a virtual camera position of the interpolated frame.

3. The method of claim 1, further comprising:
storing each motion vector of the plurality of motion vectors and the weight assigned to each motion vector, wherein
selecting the first motion vector comprises sampling the plurality of motion vectors intersecting the first location and selecting the motion vector having the highest weight.

4. The method of claim 3, wherein storing comprises separately storing an x coordinate and a y coordinate of each motion vector.

5. The method of claim 4, wherein sampling comprises, for each motion vector, separately writing the x coordinate and the y coordinate to the first location in an atomic operation.

6. The method of claim 5, wherein the first location is a distance from each endpoint of the motion vector based on a number of interpolated frames being generated between the current frame and the previous frame.

7. The method of claim 1, further comprising:
replacing an invalid motion vector of the plurality of motion vectors with a first valid adjacent motion vector of the plurality of motion vectors.

8. The method of claim 7, wherein replacing the invalid motion vector comprises selecting the first valid adjacent motion vector from a plurality of valid adjacent motion vectors based on the first valid adjacent motion vector being furthest of the plurality of valid adjacent motion vectors from a virtual camera position of the interpolated frame.

9. A processing system comprising:
an accelerator unit (AU) configured to:
assign a weight to each motion vector of a plurality of motion vectors of a current frame that are estimated to intersect a first location of an interpolated frame between the current frame and a previous frame;
select a first motion vector from the plurality of motion vectors based on the weight of the first motion vector to generate a motion vector field for the interpolated frame; and
generate the interpolated frame based on the motion vector field.

10. The processing system of claim 9, wherein the weight is based on a distance of the first motion vector from a virtual camera position of the interpolated frame.

11. The processing system of claim 9, wherein the AU is further configured to:
store each motion vector of the plurality of motion vectors and the weight assigned to each motion vector; and
select the first motion vector by sampling the plurality of motion vectors intersecting the first location and selecting the motion vector having the highest weight.

12. The processing system of claim 11, wherein the AU is further configured to:
separately store an x coordinate and a y coordinate of each motion vector.

13. The processing system of claim 12, wherein the AU is further configured to:
for each motion vector, separately write the x coordinate and the y coordinate to the first location in an atomic operation.

14. The processing system of claim 13, wherein the first location is a distance from each endpoint of the motion vector based on a number of interpolated frames being generated between the current frame and the previous frame.

15. The processing system of claim 9, wherein the AU is further configured to:
replace an invalid motion vector of the plurality of motion vectors with a first valid adjacent motion vector of the plurality of motion vectors.

16. The processing system of claim 15, wherein the AU is further configured to:
select the first valid adjacent motion vector from a plurality of valid adjacent motion vectors based on the first valid adjacent motion vector being furthest of the plurality of valid adjacent motion vectors from a virtual camera position of the interpolated frame.

17. A processing system, comprising:
an accelerator unit (AU) configured to:
generate a motion vector field for an interpolated frame between a current rendered frame and a previous rendered frame based on a plurality of selected motion vectors, wherein each selected motion vector is selected from a plurality of motion vectors of the current rendered frame that are estimated to intersect a location of the interpolated frame based on a weight of each motion vector of the plurality of motion vectors; and
generate the interpolated frame based on the motion vector field.

18. The processing system of claim 17, wherein the weight is based at least in part on a distance of each motion vector of the plurality of motion vectors from a virtual camera position of the interpolated frame.

19. The processing system of claim 17, wherein the AU is further configured to:
store each motion vector of the plurality of motion vectors and the weight assigned to each motion vector; and
select each selected motion vector by sampling the plurality of motion vectors of the current rendered frame that intersect a location of the interpolated frame and selecting the motion vector having the highest weight.

20. The processing system of claim 17, wherein the AU is further configured to:
for each motion vector, separately write an x coordinate and a y coordinate to the location in an atomic operation.
